(19) United States
(12) Patent Application Publication
(10) Pub. No.: US 2004/0122892 A1
(43) Pub. Date: Jun. 24, 2004

(54) Method, apparatus, and computer-program product for event service declaration, registration, and notification

(76) Inventors: Peter J. Brittenham, Pittsboro, NC (US); Kyle Brown, Apex, NC (US); Stephen Graham, Chapel Hill, CA (US); Mark D. Weitzel, Durham, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 10/328,873

(22) Filed: Dec. 24, 2002

(51) Int. Cl. G06F 15/16

(52) U.S. Cl. 709/203; 709/238

(57) ABSTRACT

An “event registration service” that enables unrelated and “uncoordinated” systems (i.e. systems that have not planned advance to work together by using the same prerequisite software) to be linked together to facilitate event notification is disclosed. The event registration service links these unrelated systems (e.g., those that have declared events with those that have registered an interest in those events) to facilitate event notification between the unrelated systems. The event registration system functions by combining the functionality of the Web Services Inspection Language (WSIL) and XML style sheets (XSLT). In accordance with the present invention, WSIL hierarchies are built to represent event declarations ane event registrations. XSLT is used as an adapter, converting from one API (represented, for example, as a SOAP message) to another (e.g., another SOAP message representing a different data structure, such as that derived from a COBOL copybook).

### BACKGROUND OF THE INVENTION

1. Field of the Invention

This invention relates to event services and, more particularly to declaration, registration, and notification of events in a client-server environment.

2. Description of the Related Art

Mobile communications and the Internet have substantially increased the availability of information to the public. Using a PC connected to the Internet or a Web-enabled cell phone, a person can obtain information almost instantly, from breaking news to realtime stock-quotes to scores of sporting events.

This ability to track events (e.g., sports scores, stock prices, etc) has led to the development of “Web Services” using Simple Object Access Protocol (SOAP) and HyperText Transfer Protocol (HTTP). HTTP is a the well-known protocol used by Web servers and client browsers to move documents (in electronic form) around the Internet. SOAP is a way for a program running in one kind of operating system (such as Windows 2000) to communicate with a program in the same or another kind of an operating system (such as Linux) by using HTTP and its Extensible Markup Language (XML) as the mechanisms for information exchange. Since Web protocols are installed and available for use by all major operating system platforms, HTTP and XML provide a ready-made solution to the problem of how programs running under different operating systems in a network can communicate with each other. SOAP specifies exactly how to encode an HTTP header and an XML file so that a program in one computer can call a program in another computer and pass it information. It also specifies how the called program can return a response. All of this is well known in the art.

One of the major problems with current designs for Web Services is that they are “poll” only. This means that if two systems communicating over SOAP and HTTP need to be able to swap data, then if the system requesting the data (the client) needs to get the most recent copy of the data from the system providing the data (the server), the only way is for the client to periodically send messages to the server requesting a new version of the data. In the sports-scores example, for instance, the client requesting the sports scores from a server supplying the scores will have to send a request to the server on a periodic basis, in essence saying “send me the score for the last completed inning” (using a baseball example), and the server will oblige. If the inning hasn't changed since the last request, the same scores are returned; once the inning ends, the new scores are sent upon receipt of the next request. This is known as “polling” and is wasteful of resources in both systems and generates a significant amount of unnecessarily duplicate network traffic.

An alternative commonly used is to let the server and the client communicate over an asynchronous protocol such as Java Message Service (JMS) interfacing with IBM's WebSphere MQ, TIBCO's Active Enterprise, or other similar message-oriented middleware (MOM), so that whenever something happens in the server that the client is interested in (e.g., the end of an inning), the server will “publish” a message to a JMS Topic or Queue to which the client has access (for additional information regarding the standard Java JMS specification, please refer to ______ incorporated herein by reference).

A problem with this alternative is that while it does provide the asynchronous notification desired, it requires that the prerequisite MOM software to support JMS be available on both systems, and that the two systems be able to communicate using the features of the MOM. This can be expensive since more software is required, and also may run into problems with firewall setups, since MOM software was developed for use in intranet communication and was not designed to work in the more open and less secure Internet environment.

Thus, what is needed is a way for web services to communicate asynchronously, e.g., to provide asynchronous event notification, over a standard communication protocol such as HTTP, without the need for the client and server to be using the same prerequisite software.

### SUMMARY OF THE INVENTION

The present invention introduces a novel “event registration service” that enables unrelated and “uncoordinated” systems (i.e. systems that have not planned advance to work together by using the same prerequisite software) to be linked together to facilitate event notification. The event registration service of the present invention links these unrelated systems (e.g., those that have declared events with those that have registered an interest in those events) to facilitate event notification between the unrelated systems.

The event registration system functions by combining the functionality of the Web Services Inspection Language (WSIL) and XML style sheets (XSLT). In accordance with the present invention, WSIL hierarchies are built to represent event declarations and event registrations. XSLT is used as an adapter, converting from one API (represented, for example, as a SOAP message) to another (e.g., another SOAP message representing a different data structure, such as that derived from a COBOL copybook).

### BRIEF DESCRIPTION OF THE DRAWINGS

FIG. 1 is a block diagram illustrating the various elements of a system that can make use of the present invention;

FIG. 2 is a flowchart illustrating the basic steps involved in the declaration step of the present invention;

FIG. 2A is an illustration of a WSIL root document;

FIG. 2B is an illustration of the WSIL root document in modified form;

FIG. 3 is a flowchart illustrating the basic steps involved in event registration accordance with the present invention;

FIG. 3A illustrates a second WSIL structure; and

FIG. 4, which is a flowchart illustrating an example of the steps performed for event notification.

### DETAILED DESCRIPTION OF THE PREFERRED EMBODIMENTS

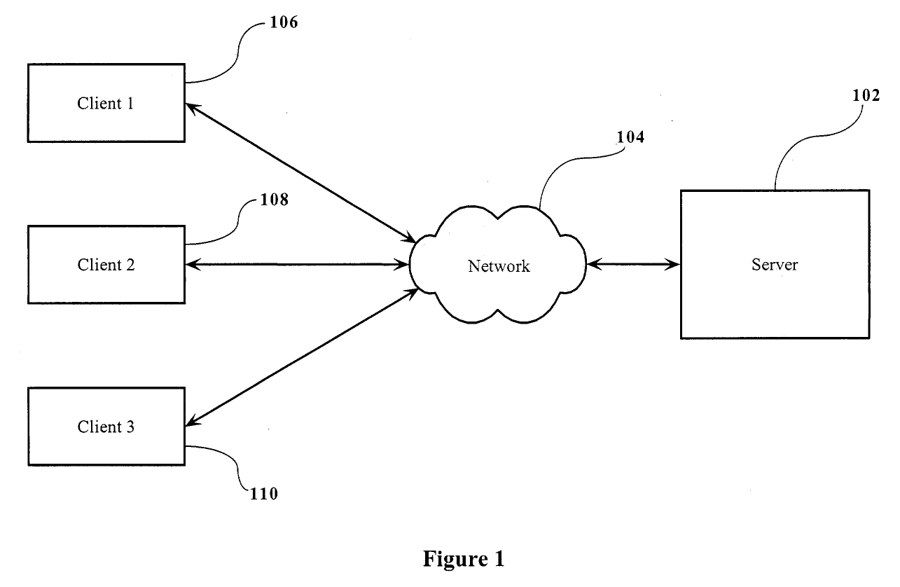

All event systems, including those of the prior art, require that (a) an event be declared; (b) interest in a declared event be registered; and (c) notification of the occurrence of the event take place. FIG. 1 is a block diagram illustrating the various elements of a system that can make use of the present invention. Referring to FIG. 1, an event server 102 is connected via a network connection (e.g., a LAN, WAN, or the Internet) to one or more clients. In the example of FIG. 1, three such clients 106, 108, and 110 are illustrated.

The basic operation of the system of FIG. 1 as an event system is as follows. Server 102 makes a declaration to the network that it has available one or more events for delivery upon request. Clients 106, 108, and 110 may register with server 102 for one or more of these events, i.e., they identify to server 102 that they would like event information of some kind delivered to them. Upon the occurrence of the events registered, event server 102 delivers the appropriate event information to the appropriate clients.

As noted above, for the systems of the prior art to function properly, in an asynchronous manner, server 102 and each of the clients 106, 108, and 110 must have some type of message-oriented middleware, i.e., there must be some level of preplanning involved to allow the events to be delivered asynchronously. The present invention obviates the need for such preplanning.

The operation of the present invention is described, for purpose of example only, in connection with a hypothetical scenario involving the Sports Providers Information Network (SPIN), a service that provides sports scores in real-time for Baseball and Basketball. They have decided that in order to avoid “Web storms” (unexpected, significant increases in web traffic to a web site) they will provide the event registration service with the scores of the games they are following at the end of quarters (basketball) or innings (baseball). Anyone wishing to receive real-time sports scores for the events offered by SPIN may request notification.

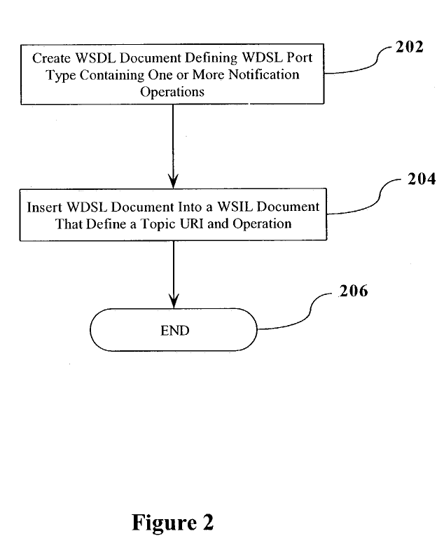

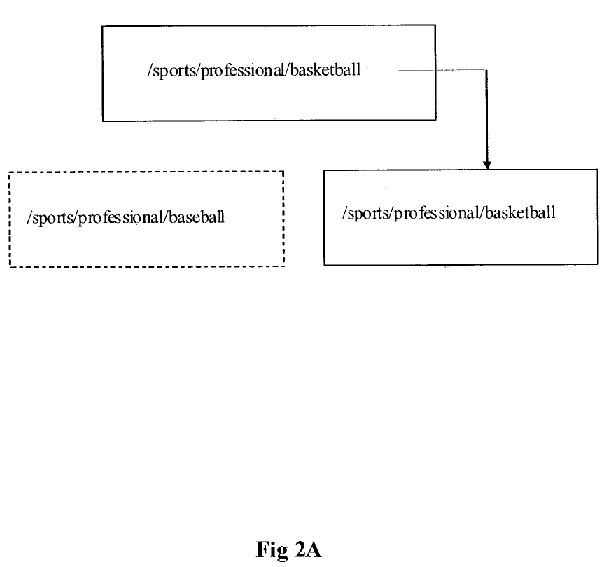

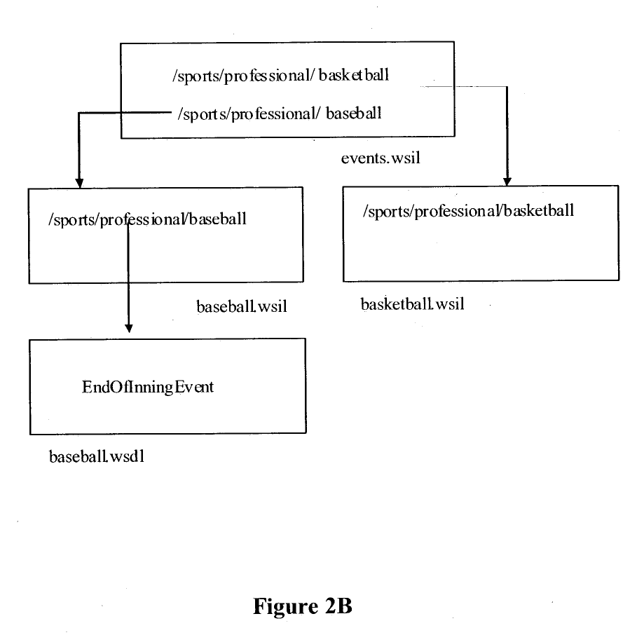

FIG. 2 is a flowchart illustrating the basic steps involved in the declaration step of the present invention. Referring to FIG. 2, at step 202, the event declaration procedure begins with the creation, by the developer of the program doing the notification, e.g., the event server, of a WSDL (Web Services Definition Language) document that defines a WSDL port-type containing one or more “notification” operations. The WSDL document contains the information necessary for client programs to discover what services are being offered, e.g., the detailed structure of the information passed on in the notification. As defined in the WSDL specification (http://www.w3.org/TR/wsdl) a notification operation (see WSDL specification section 2.4.4) is one that contains only an output portion—it can represent a SOAP (Simple Object Access Protocol—see http://www.w3.org/TR/SOAP/) message or a message in another format that represents outgoing information without any input information.

Likewise, software capable of generating the SOAP message corresponding to this described output must be created by the developer of the server software. For example, if an event system is going to deliver hockey scores to subscribers, the developer must build a WSDL document that describes the format of the scores themselves, and then build server software that produces the scores, fetching them from a wire service, database, or another web site.

A sample WSDL document for the SPIN example is shown as follows:

```
<?xml version=“1.0”?>
<definitions name=“SPIN-RealtimeInfo-interface”
  targetNamespace=“ SPIN-RealtimeInfo -interface”
  xmlns:spin=“ SPIN-RealtimeInfo -interface”
  xmlns:xsd=“http://www.w3.org/1999/XMLSchema”
  xmlns:soap=“http://schemas.xmlsoap.org/wsdl/soap/”
  xmlns=“http://schemas.xmlsoap.org/wsdl/”>
  <types>
  <xsd:schema targetNamespace=“ SPIN-RealtimeInfo-interface ”>
    <xsd:complexType name=“InningScoreInformation”>
  <sequence>
      <xsd:element minOccurs=“1” maxOccurs=“1” name=“inning”
type=“xsd:string”/>
      <xsd:element minOccurs=“1” maxOccurs=“1” name=“homeTeam”
type=“xsd:string”/>
      <xsd:element minOccurs=“1” maxOccurs=“1” name=“homeScore”
type=“xsd:int”/>
      <xsd:element minOccurs=“1” maxOccurs=“1” name=“awayTeam”
type=“xsd:string”/>
      <xsd:element minOccurs=“1” maxOccurs=“1” name=“awayScore”
type=“xsd:int”/>
      <xsd:element minOccurs=“1” maxOccurs=“1” name=“stats”
type=“xsd:string”/>
      <xsd:element minOccurs=“1” maxOccurs=“1” name=“commentary”
type=“xsd:string”/>
    </sequence>
</xsd:complexType>
  </types>
  <message name=“EndOfInningEvent”>
  <part name=“EndOfInningPart” type=“spin:InningScoreInformation”/>
  </message>
  <portType name=“EventsPort”>
  <operation name=“EndOfInningEvent”>
    <output message=“spin:EndOfInningEvent”/>
  </operation>
  </portType>
```

In the above example, each element performs a particular function. The information between the “types” tags defines the structure of the information provided in the notification. The information between the “message” tags describes how the information is joined together into a message (there can be multiple arguments or “parts” to a message; in this example there is only one. The information between the “portType” tags describes how messages are joined together into a “type” that can provide several different forms of information as described in the previously-referenced WSDL specification, e.g., end-of-inning events and end-of-game events.

At step 204, the WSDL document is inserted into a WSIL document that defines a topic URI and operation. Events are described by two pieces of information. The topic URI represents an abstract description of the type of event that is being generated; for instance, in a service that broadcasts sports scores, the topic URI would describe the type of scores being distributed, for instance “/sports/professional/baseball” or “/sports/college/basketball”. The URI's represent a tree structure of possible event topics. Each new event will fit somewhere within this tree structure. This tree structure is used by the client program (the receiver of event notifications) to determine which events are available when it registers to receive an event notification.

The insertion is done through the use of an WSIL extensibility element (see WSIL specification, section 2.1.1) that provides the ability to locate the WSDL document within the event hierarchy defined by the topic URI's.

As an example, assume that the hierarchy shown in FIG. 2A is already defined. The root of this hierarchy would be a WSIL document that contains link elements that refer to the individual topic documents. The process begins with the most complicated case, which is where no event declaration exists for a particular topic (in the example of FIG. 2A, this would be /sports/professional/baseball). Prior to the insertion of the new element, the WSIL root document would look like this:

```
<?xml version=“1.0”?>
<inspection xmlns=“http://schemas.xmlsoap.org/ws/2001/10/inspection”
                                          xmlns:wsevent =
“http://tempuri.org/ws/2002/2/event/”>
                    < l i n k
referencedNamespace=
“http://schemas.xmlsoap.org/ws/2001/10/inspection”
location=“http://example.com/sports/professional/basketball.WSIL” />
      <wsevent:eventReference topic=“/sports/professional/basketball”/>
    </link>
  </inspection>
```

Since this is a new topic, a new link element containing an event reference element is created. After the insertion of the new element (shown in bold typeface below), the root document will look like the following:

```
<?xml version=“1.0”?>
<inspection xmlns=“http://schemas.xmlsoap.org/ws/2001/10/inspection”
                                              xmlns:wsevent =
“http://tempuri.org/ws/2002/2/event/”>
                        < l i n k
referencedNamespace=
“http://schemas.xmlsoap.org/ws/2001/10/inspection”
location=“http://example.com/sports/professional/basketball.WSIL” />
    <wsevent:eventReference topic=“/sports/professional/basketball”/>
  </link>
                        < l i n k
referencedNamespace=
“http://schemas.xmlsoap.org/ws/2001/10/inspection”
location=“http://example.com/sports/professional/baseball.WSIL” />
    <wsevent:eventReference topic=“/sports/professional/baseball”/>
  </link>
  </inspection>
```

The new link refers to an additional WSIL document that contains the declaration of the new event operations that client programs may subscribe to. That document would look like the following:

```
<?xml version=“1.0”?>
<inspection xmlns=“http://schemas.xmlsoap.org/ws/2001/10/inspection/”
          xmlns:wsevent=“http://tempuri.org/ws/2002/2/event/”>
  <service>
            <description
referencedNamespace=“http://schemas.xmlsoap.org/wsdl/”
location=“http://example.com/sports/professional/baseball/baseball.w
sdl”>
    <wsevent:eventDeclaration
          operation=“EndOfInningEvent”/>
    </description>
  </service>
</inspection>
```

At the completion of this step, the final hierarchy will look as shown in FIG. 2B. With this revised hierarchy, a WSIL document now exists that clients can traverse to determine what topics are available, what event operations may be registered for, and what the detailed structure of the event messages are.

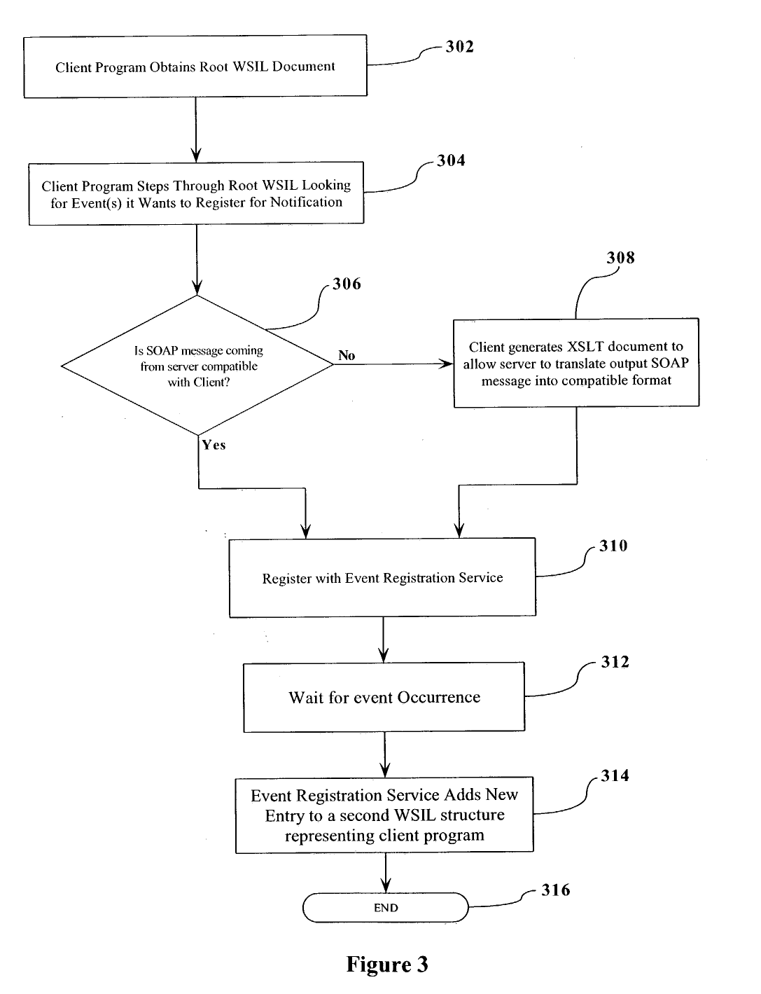

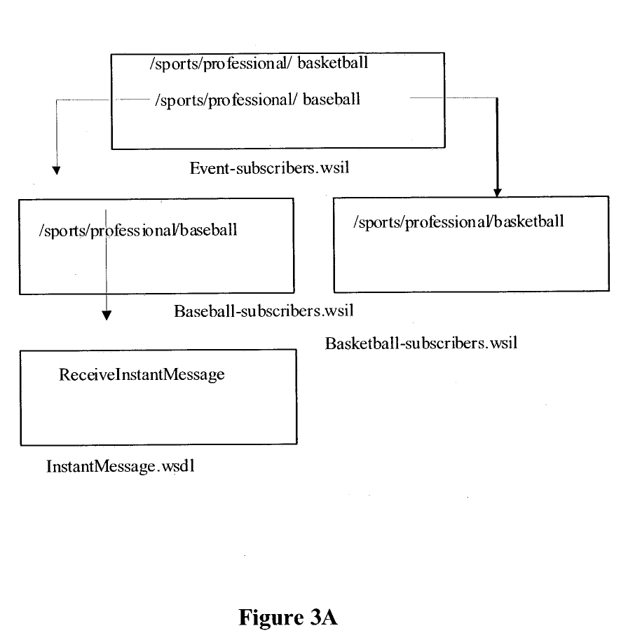

Once the events have been declared, the next step is event registration. FIG. 3 is a flowchart illustrating the basic steps involved in event registration accordance with the present invention. Referring to FIG. 3, at step 302, the event registration procedure begins with a client program (that is the program that will be notified through a web service when a particular event occurs) obtaining the root WSIL document. The document may be obtained from any known mechanism for obtaining WSIL documents, such as from a web server, generated from an application from information stored in a database, or read from a shared hard-disk drive.

Next, at step 304, the client program steps through the root WSIL document looking for the particular event hierarchy that matches the event(s) for which notification is desired. It identifies the hierarchy by comparing the topic URI's in the eventReference tags to a previously known event hierarchy description. For instance, if the client program wants to register for scores in professional baseball, it would search for an eventReference tag that had a topic that matched “/sports/professional/baseball”. It is possible that this step may be interactive with a human user in that the list of event references available in this document can be displayed to the user and the user can select a particular event reference that is of interest. This navigation may be done through the use of common API's such as WSIL4J.

Next, the client program will follow the “location” reference in the eventReference tag to find the WSIL document corresponding to that topic URL. Note that this sub-step may be recursive—this may lead to a document that contains other WSIL link tags that each contain another eventReference to another WSIL document. At the point where the client finds the lowest document of interest on the event tree of interest, the recursive references will end and the client program will obtain a WSIL document that contains one or more eventDeclaration tags inside of WSIL description tags.

At this point, step 304 is completed. The client program has identified a particular topic URI and a particular operation that corresponds uniquely to an operation in the WSDL document referred to by the WSIL declaration tag containing the eventDeclaration tag for that operation. The WSDL document and the operation name will be used in step 306.

Step 306 is an optional step, depending upon the formats of the SOAP messages. At step 306, a determination is made as to whether or not the SOAP message coming from the event server is compatible with the client In most cases, the SOAP message that the client program is designed to receive will not match the format of the SOAP message that the operation in the WSDL identified in step 304. Given this mismatch, a translation must occur at the event server so that the SOAP message the client receives matches (in format) what it expects to receive. Thus, the client program will generate an XSLT document (step 308) to allow the server to translate the output XML document (the output SOAP message) into another XML document (the SOAP message in a format that the client expects to receive).

If the SOAP message coming from the server is compatible with the client, the client program does not generate the XSLT document, and it is assumed that the SOAP message the client receives will exactly match the structure of the SOAP message corresponding to the operation defined in the WSDL referred to in Step 304.

At step 310, the client program registers with the event registration service stored on the event server. To do this, the client program provides the following information to the event registration service:

1. A WSDL document describing the exact location where the client program will “listen” for a one-way web service invocation. This WSDL document must contain a Service containing a port bound to SOAP, which refers to a particular WSDL operation defined as a WSDL one-way (as explained in section 2.4.1 of the WSDL specification) operation. This is known as a Service/Port/Operation triplet. An example of this kind of document is shown below;

2. The names of the Service/Port/Operation triplet contained within the WSDL document that uniquely defines the particular message structure that this client program expects to receive;

3. The name of the topicURI and the name of the operation that the client wishes to be notified of when the corresponding event occurs;

4. (Optional) a Filter String that consists of a set of query elements (which could be defined using, for example, Xquery, described at http://www.w3.org/TR/xquery/, or any other query language (such as a derivative of the ANSI SQL-92 standard) that allows the formulation of queries based on known structured data. This filter string would describe a subset of SOAP messages that the client program elects to receive. For instance, in the WSDL document described above, one of the data elements is the field “homeTeam”. A query of this type could be phrased as “homeTeam=Cardinals”. This would mean that this client wishes to receive notification of scores only for games played by the St. Louis Cardinals; and

5. (Optional) An XSLT document (of the type described above with respect to step 308) that would allow translation from the output SOAP format described by the WSDL to the input SOAP format provided by the WSDL document in part 1 of step 310. If no such document is provided, it is assumed that the SOAP formats for the notification operation and the one-way operation described by the two WSDL documents match exactly.

At the completion of step 310, the client program will then wait for notification of the occurrence of the event (step 312).

The following is an example of a client program WSDL document, created in accordance with step 310, defining a one-way operation:

```
<?xml version=“1.0”?>
<definitions name=“InstantMessage”
targetNamespace=“http://example.com/instantmessage.wsdl”
      xmlns:tns=“http://example.com/instantmessage.wsdl”
      xmlns:xsd1=“http://example.com/instantmessage.xsd”
      xmlns:soap=“http://schemas.xmlsoap.org/wsdl/soap/”
      xmlns=“http://schemas.xmlsoap.org/wsdl/”>
  <types>
    <schema targetNamespace=“http://example.com/instantmessage.xsd”
        xmlns=“http://www.w3.org/2000/10/XMLSchema”>
      <element name=“InstantMessageData”>
        <complexType>
          <all>
            <element name=“message” type=“string”/>
          </all>
        </complexType>
      </element>
    </schema>
  </types>
  <message name=“InstantMessageReceived”>
    <part name=“body” element=“xsd1:InstantMessageData”/>
  </message>
  <portType name=“InstantMessagePortType”>
    <operation name=“ReceiveInstantMessage”>
      <input message=“tns:InstantMessageReceived”/>
    </operation>
  </portType>
          <binding name=“InstantMessageSoapBinding”
type=“tns:InstantMessagePortType”>
                              <soap:binding style=“document”
transport=“http://schemas.xmlsoap.org/soap/http”/>
    <operation name=“ReceiveInstanteMessage”>
                                        <soap:operation
soapAction=“http://example.com/InstantMessageReceived”/>
      <input>
        <soap:body use=“literal”/>
      </input>
    </operation>
  </binding>
  <service name=“InstantMessageService”>
                            <port name=“InstantMessagePort”
binding=“tns:InstantMessageBinding”>
    <soap:address location=“http://example.com/instantmessage”/>
    </port>
    </service>
  </definitions>
```

At step 314, the event registration service adds a new entry to a second WSIL structure representing this client program. It does so through the addition of an event tag within a description tag for a particular client. For example, consider the following WSIL document:

```
<?xml version=“1.0”?>
<inspection xmlns=“http://schemas.xmlsoap.org/ws/2001/10/inspection/”
          xmlns:wsevent=“http://tempuri.org/ws/2002/2/event/”>
  <service>
  <description referencedNamespace=“http://schemas.xmlsoap.org/wsdl/”
location=“http://subscriber1.com/instantmessenger.wsdl”>
    <wsevent:event xmlns:msg=“http://subscriber1.com/InstantMessage/”
                    serviceName=“msg:InstantMessageService”
                    portName=“msg:InstantMessagePort”
                    inboundOperation=“ReceiveInstantMessage”
                    topicURI=“/sports/professional/baseball”
                    outboundOperation=“GetEndOfInningScore”
                transform=“http://subscriber1.com/BaseballService.xsl”
                    filter=“[filter string]”
/>
    </description>
  </service>
</inspection>
```

This document states that the client specified uniquely by the combination of serviceName, portName and operation defined in the WSDL document found at location should receive notifications for the topic URI and outbound operation specified. The server uses the XSLT document found at the URL specified in transform to convert from its SOAP message format to the one specified by the serviceName, portName, inboundOperation triplet. Furthermore, the string specified by “filter” is used to evaluate each outgoing SOAP message to determine if it should be sent to this client or not. This second WSIL structure is shown in FIG. 3A.

As can be seen in FIG. 3A, each WSDL document representing the client's desired interface is placed into a WSIL hierarchy along with the other information such as topic URI and outbound operation, XSLT document reference, filter string, and inbound service name, port name and inbound operation triplet that uniquely identifies the operation in the client WSDL that will be invoked upon event notification. Thus, in the event notification stage (below) the event server will have all of the information necessary to notify the client in its preferred format upon event occurrence. All of this information is stored in a WSIL document referred to by the topicURI from other WSIL documents higher in the topic URI hierarchy in the form of a WSIL extension tag. In the example, this extension tag is named “event”.

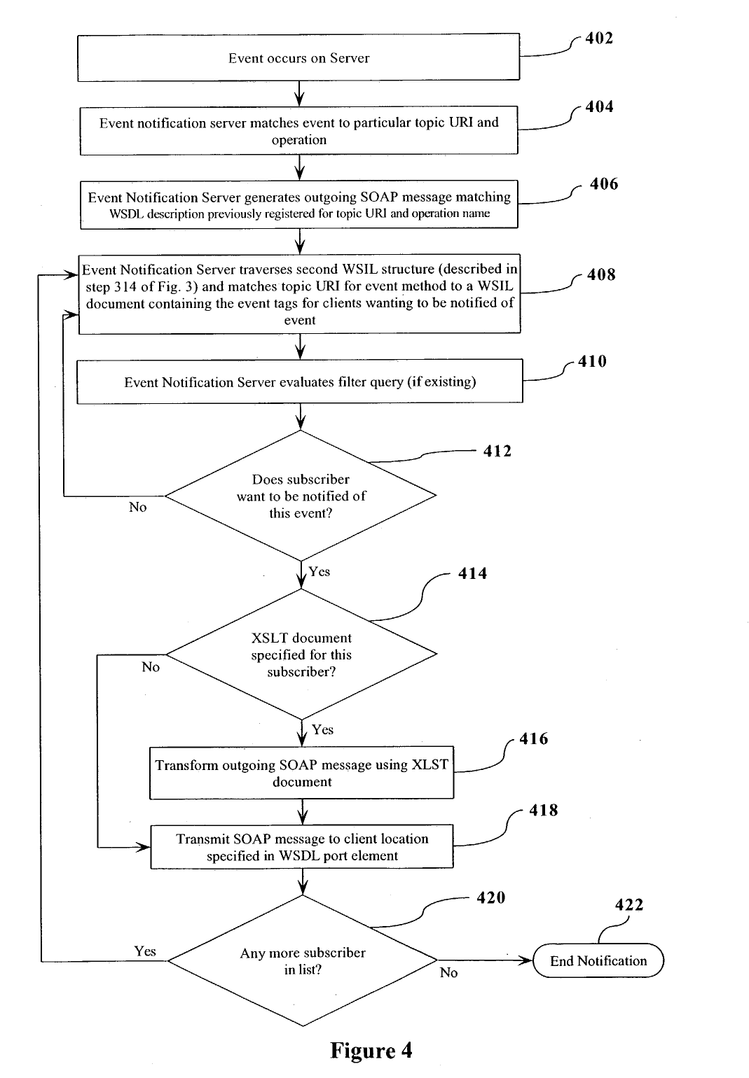

The last element, event notification, is described with reference to FIG. 4, which is a flowchart illustrating an example of the steps performed for event notification. Referring to FIG. 4, the event notification process begins with an event occurring on the server (step 402). The event could be triggered by a user action, by receipt of a message or notification, by the action of a timer, or by any other means of invoking a method on the server. The server is configured to trigger an external notification based on this internal event.

At step 404, the event server matches the event to a particular topic URI and operation. In the simplest case this information could be passed in to the method that triggered the event, such as in the following method:

triggerEvent(String topicURI, String operationName, [other parameters])

The “other parameters” may include, for example, parameters to be passed to the external client programs in the outgoing SOAP notification message; in the SPIN example, such information might include the home team name, the away team name, and the final score of the ballgame.

At step 406, the event notification server generates an outgoing SOAP message matching the WSDL description previously registered for this topic URI and operationName in the Event Declaration procedure. This SOAP message will eventually be sent to the client(s), either in its “raw” form or transformed to be compatible with the client(s).

At step 408, the event notification server traverses the second WSIL structure (described in step 314 of FIG. 3) and matches the topic URI for the event method invoked in step 404 to a WSIL document containing the event listener registrations (the event tags) for the client programs wanting to be notified of this event. The event notification server also traverses through the list of registered client programs in this WSIL document (searching through the event tags) to create a list of subscribers who desire notification of both this topic URI and outbound operation.

At step 410, the event notification server evaluates any filter queries for this subscriber and determines if this subscriber wishes to be notified about this particular event based on the information contained in the SOAP message created in step 406.

At step 412, if the result of evaluating the filter queries indicates that this subscriber does wish to be notified about this event (or there was no filter string specified) then the server proceeds to step 414 for this subscriber. If the result of evaluating the query indicates that this subscriber does not wish to be notified about this event, the procedure is finished processing this subscriber and returns to step 408 to begin evaluation of the next subscriber.

At step 414, if there is an XSLT document specified for this subscriber (e.g. an XSLT document was supplied during the registration phase for this subscriber in step 314 of FIG. 3), the process proceeds to step 416 for this subscriber. Otherwise, the process proceeds directly to step 418.

At step 416, the outgoing SOAP message is transformed using the XSLT document referenced in Step 414 so that a new SOAP message is generated. At step 418, the SOAP message (either the original or the new one generated during step 416) is transmitted to the client location specified in the WSDL port element for the subscriber specified in step 314 of FIG. 3.

At step 420, if there are any subscribers left in the list, the process returns to step 408 for processing of the remaining subscribers. Otherwise (i.e., if there are no more subscribers to be processed), the event notification procedure is terminated.

Using the invention as described above, many benefits may be achieved. These benefits include, but are not limited to:

(1) The use of WSIL for declaring events allows client programs written in any language that supports XML to discover events available for registration;

(2) The use of XSLT for translating outgoing event notifications into a client-specific form allows clients to listen to events from several different sources—e.g. an instant messaging client could listen for both sports scores and stock ticker information from two different sites;

(3) The use of WSIL to represent the tree of subscribers allows the event notification server and the individual pieces of code that generate the events to be written in two different languages—for instance the portion of the server that accepts notification could be written in Java, while the portion that generates the events and sends out the notifications could be written using Visual Basic or C++.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-4 support combinations of means for performing the specified functions, combinations of steps for performing the specified functions, and program instruction means for performing the specified functions.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage in the event server. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Although the present invention has been described with respect to a specific preferred embodiment thereof, various changes and modifications may be suggested to one skilled in the art. For example, the example described herein relates to web-based event systems such as the providing of real-time sports scores, stock prices, and the like. However it is understood that the present invention can be used in other web-based event services, as well as non-web-based systems. As one example, the present invention could be used in a factory environment where different machines on the factory floor need to be shut down when an emergency occurs. In this case, the machines would register for notification on a “shut down” event, via the factory network, with a factory control server that controls the factory operations. The different machines are controlled by the client programs as described herein), while the factory control server would provide the notification function described herein. In this example, there are two non-human parties involved. When the factory control server identifies the existence of the reaching of an internal limiting factor (e.g., the factory is completely out of some crucial part) then it would issue the “shut down” event—all of the client machines would receive the message tailored to their particular control protocol. The message received by a robot that moves material could be “return to base station” while the message received by an automated painting machine could be “drain paint and go into rest mode”.

It is intended that the present invention encompass such changes and modifications as fall within the scope of the appended claims.

We claim:

1. A method for event declaration, registration and notification in an event system, comprising the steps of:
creating a WDSL document defining a WDSL port-type containing one or more notification operations;
inserting said WDSL document into a root WSIL document defining a topic URI and operation;
storing said root WDSL document on an event server;
obtaining said root WSIL document by a client;
identifying, by said client, events specified in said root WSIL document; and
registering, by said client, said identified events so that said event server delivers event information pertaining to said identified events to said client at a predetermined interval.

2. A system for event declaration, registration and notification in an event system, comprising:
means for creating a WDSL document defining a WDSL port-type containing one or more notification operations;
means for inserting said WDSL document into a root WSIL document defining a topic URI and operation;
means for storing said root WDSL document on an event server;
means for obtaining said root WSIL document by a client;
means for identifying, by said client, events specified in said root WSIL document; and
means for registering, by said client, said identified events so that said event server delivers event information pertaining to said identified events to said client at a predetermined interval.

3. A computer program product for event declaration, registration and notification in an event system, the computer program product comprising a computer-readable storage medium having computer-readable program code embodied in the medium, the computer-readable program code comprising:
computer-readable program code that creates a WDSL document defining a WDSL port-type containing one or more notification operations;
computer-readable program code that inserts said WDSL document into a root WSIL document defining a topic URI and operation;
computer-readable program code that stores said root WDSL document on an event server;
computer-readable program code that obtains said root WSIL document by a client;
computer-readable program code that identifies, by said client, events specified in said root WSIL document; and
computer-readable program code that registers, by said client, said identified events so that said event server delivers event information pertaining to said identified events to said client at a predetermined interval.
